(19) United States
(12) Patent Application Publication
(10) Pub. No.: US 2024/0342514 A1
(43) Pub. Date: Oct. 17, 2024

(54) MODULAR FULL-FACE RESPIRATOR

(71) Applicant: Travis REESE, Evansville, IN (US)

(72) Inventor: Travis REESE, Evansville, IN (US)

(21) Appl. No.: 18/134,424

(22) Filed: Apr. 13, 2023

(51) Int. Cl. A62B 9/04; A62B 9/02; A62B 18/02; A62B 18/08; A62B 18/10

(52) U.S. Cl. CPC A62B 9/04; A62B 9/02; A62B 18/02; A62B 18/08; A62B 18/10

(57) ABSTRACT

A full-face respirator apparatus includes a face shield including a first aperture, a second aperture, and a third aperture. A first connection interface is positioned at the first aperture to removably connect the first aperture with a first respirator component. A second connection interface is positioned at the second aperture to removably connect the second aperture with a second respirator component. A third connection interface is positioned at the third aperture to removably connect the third aperture with a third respirator component. The first, second, and third connection interfaces have different connection structures to support different types of respirator components to provide modular configurability and ease of repair and maintenance.

### BACKGROUND OF THE INVENTION

### Field of the Invention

The present invention relates to respiratory protection devices and respirators.

### Description of the Related Art

Respiratory protection devices (also referred to as respirators) provide breathable air supply to a wearer and are used in a variety of different applications. The respirators can be used during fires, military operations, and hazardous industrial applications where the natural air supply may be contaminated. In addition to providing a clean air source to the nose and mouth for breathing when provided with a suitable filter, full-face respirators also protect the eyes and face from harmful or irritating gases and other substances. The devices can further include mounts for detachable and replaceable filter elements or connection to air supply.

### SUMMARY OF THE INVENTION

According to one aspect of the present disclosure, a full-face respirator apparatus includes a face shield including a first aperture, a second aperture, and a third aperture. The apparatus further includes a first connection interface positioned at the first aperture. The first connection interface is to removably connect the first aperture with a first respirator component. The apparatus further includes a second connection interface positioned at the second aperture. The second connection interface is to removably connect the second aperture with a second respirator component. The second connection interface has a structure different from the first connection interface. The apparatus further includes a third connection interface positioned at the third aperture. The third connection interface is to removably connect the third aperture with a third respirator component. The third connection interface has a structure different from the first connection interface and the second connection interface.

According to one aspect of the present disclosure, a full-face respirator apparatus includes a face shield including a first aperture, a second aperture, and a third aperture. The apparatus further includes a first connection interface positioned at the first aperture. The apparatus further includes a first respirator component including a plug, an inhalation valve with a bayonet connector to connect to a complementary bayonet connector of an air supply component or a plug, or a microphone device. The first connection interface is configured to removably connect the first aperture with the first respirator component. The apparatus further includes a second connection interface positioned at the second aperture. The apparatus further includes a second respirator component including an exhaust valve, a voice diaphragm, or a radio transmitter or receiver device. The second connection interface is configured to removably connect the second aperture with the second respirator component. The second connection interface has a structure different from the first connection interface. The apparatus further includes a third connection interface positioned at the third aperture. The apparatus further includes a third respirator component including an inhalation valve with a thread to connect to a complementary thread of an air supply component or a plug, or an exhaust valve. The third connection interface is configured to removably connect the third aperture with the third respirator component. The third connection interface has a structure different from the first connection interface and the second connection interface.

Various other objects, advantages, features, and characteristics of the present invention, as well as the methods of operation and functions of related structural elements, and the combination of parts and economies of development and manufacture, will become readily apparent to those of ordinary skill in the art upon consideration of the detailed description below with reference to the accompanying drawings, all of which form a part of this specification.

### BRIEF DESCRIPTION OF THE DRAWINGS

A further understanding of the present invention can be obtained by reference to preferred embodiments set forth in the illustrations of the accompanying drawings. The drawings are not intended to limit the scope of this invention, but merely to clarify and exemplify the invention. Accordingly, a more complete appreciation of the present invention and many of the attendant aspects thereof may be readily obtained as the same becomes better understood by reference to the following detailed description when considered in conjunction with the accompanying drawings.

FIG. 1 is a front perspective view of an example full-face respirator apparatus.

FIG. 2 is a front view of the face shield of FIG. 1.

FIG. 3 is a rear perspective view of a portion of the face shield component of FIG. 2.

FIG. 4 is a front perspective view of a portion of the face shield component of FIG. 2.

FIG. 5 is a front perspective view of an exhaust valve insert.

FIG. 6 is a rear perspective view of the exhaust valve insert of FIG. 5.

FIG. 7 is a front perspective view of a voice diaphragm retainer.

FIG. 8 is a side view of the voice diaphragm retainer of FIG. 7.

FIG. 9 is a rear perspective view of the voice diaphragm retainer of FIG. 7.

FIG. 10 is a side view of an exhaust valve according to embodiments of the present invention.

FIG. 11 is a rear view of the exhaust valve of FIG. 10.

FIG. 12 is a side view of an inhalation valve.

FIG. 13 is a rear view of a portion of the inhalation valve of FIG. 12.

FIG. 14 is a rear perspective view of a portion of the face shield component of FIG. 2.

FIG. 15 is a rear view of the interface shown in FIG. 14.

FIG. 16 is a table of example configurations of the full-face respirator apparatus of FIG. 1.

FIGS. 17A-17M are diagrams of example respirator components.

FIG. 18 is a perspective view of a harness for securing the full-face respirator apparatus of FIG. 1 to a wearer's head.

### DETAILED DESCRIPTION OF THE PREFERRED EMBODIMENTS

There are a number of respirator types in common use. Full face respirators typically include a face shield (sometimes called a lens), a face seal for mounting the face shield about the face of a wearer, and a port for providing an air supply to the wearer's face. Many of these respirator designs inhibit the use of different types and configurations of air supplies, filters, and accessories. Often a user will have to possess different respirators for different purposes.

Different types of filters may be used depending on the type of contaminant the respirator must guard against. In general, there are particulate, gas, or combination particulate/gas filters and/or canisters. Filters may utilize multiple different sizes and types of industry standard connection ports which are used to attach and seal the filter to the respirator. Such filters are often classified according to their efficiency or capacity. For example, a filter class may describe the maximum concentration of toxic substances it can handle, or how efficiently (by percentage) toxic particles are filtered from the air.

Filters may utilize multiple different sizes and types of industry standard connection ports which are used to attach and seal the filter to the respirator. Two common industry standard filter connections are the bayonet type and the 40 mm NATO connection. It is often the case that two separate and distinct full-face respirators are needed for each of the filter attachment designs described.

Many currently available full-face respirators designs have permanently installed parts and components that are not readily interchangeable. Attempting to change components on some designs may cause damage to the respirator. In addition, many known designs make necessary maintenance and repair difficult. Lack of component interchangeability and inconvenient maintenance procedures cause many users to simply purchase several specialized full-face respirators. This results in greater expense and less convenience to users. Furthermore, respirator manufacturers often need to support a large line of different models, which increases complexity and cost.

The present invention provides solutions to the above-described problems of the prior art and to other problems in the art, by way of a full-face respirator apparatus that may be fitted with various different components, such as bayonet connectors, 40 mm NATO connectors, and other components, while still maintaining compliance with various global and government filtration standards. This present invention also facilitates routine maintenance and repair and reduces the need to manufacture and purchase multiple respirators of various different designs.

The present disclosure is not intended to be limited to the specific terminology so selected, and it is to be understood that each specific element includes all technical equivalents which operate in a similar manner. Specific embodiments that may be practiced are shown by way of illustration and explanation. The embodiments are described in sufficient detail to enable those skilled in the art to practice the embodiments, and it is to be understood that logical, mechanical, and other changes may be made without departing from the scope of the embodiments. The following detailed description is therefore not to be taken in a limiting sense. In describing exemplary embodiments of the present invention illustrated in the drawings, specific terminology is employed for sake of clarity.

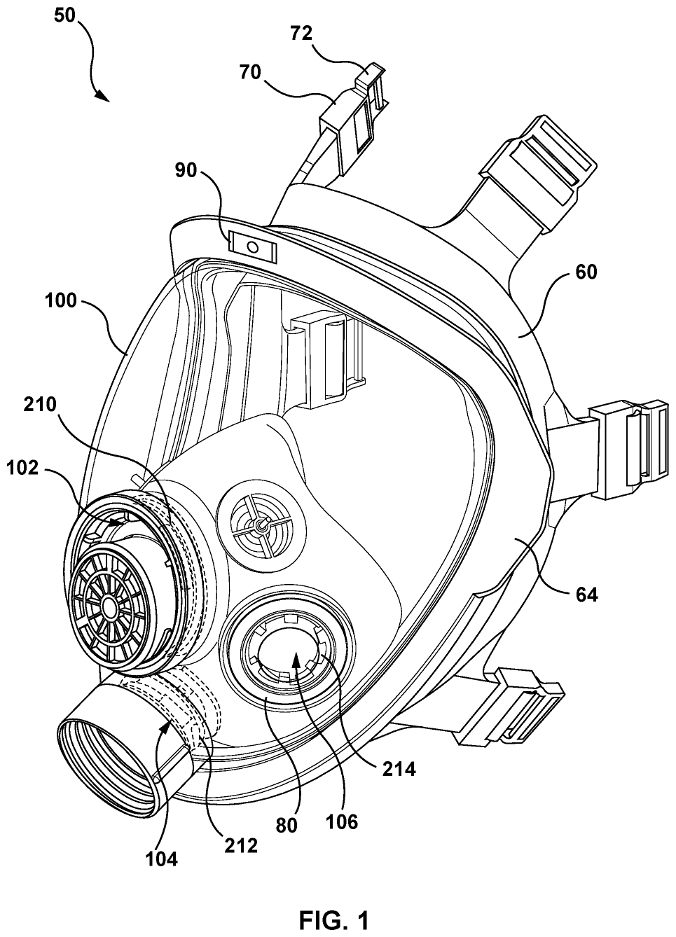

FIG. 1 shows a full-face respirator apparatus 50 according to embodiments of the present invention. The apparatus 50 includes a face seal 60, frame 64, attachment points 70, and a face shield 100.

The face seal 60 surrounds the wearer's face and forms a seal against the wearer's face. The face seal 60 may include a resilient seal element, such as a gasket or foam material, couplable with the relatively rigid frame 64, which may be termed a “clamshell”.

The attachment points 70 may be provided at various locations around the face seal 60. The attachment points 70 allow for adjustable and/or removeable attachment of a harness to secure the respirator apparatus 50 to the wearer's head and apply a force to effect sealing of the face seal 60 against the wearer's face. Each attachment point 70 includes a fastener 72, such as a clip or buckle component, for connecting to a complementary fastener of a harness. The fastener 72 may be a quick-connect/quick release fastener to allow quick donning/removal of the full-face respirator apparatus 50.

The face shield 100 is a relatively thin curved body that protects the wearer's face and forms a major component of the air-tight seal of the full-face respirator apparatus 50. The face shield 100 may be made of a single piece of material, such as a transparent, semi-transparent, or translucent plastic, such as polycarbonate, glass, or similar material. The face shield 100 may include a surface finish or treatment, such as a mirrored finish, non-reflective coating, tint, anti-fog, etc. The face shield 100 is permanently or removably attached to the face seal 60. The perimeter of the face shield 100 may be sandwiched between the face seal 60 and the clamshell 64. The clamshell 64 may be removable from the face seal 60 to allow decoupling and removal of the face shield 100. In various embodiments, the face seal 60, clamshell 64, and face shield 100 are mutually couplable to form an assembly that may be disassembled and reassembled by hand or with hand tools.

The face shield 100 includes a first aperture 106, a second aperture 102, and a third aperture 104. The apertures 102, 104, 106 may be integrally formed within the face shield 100. For example, the face shield 100 may be an injection molded piece of plastic where the apertures 102, 104, 106 are defined by the mold cavity and/or mold inserts.

The full-face respirator apparatus 50 further includes a first connection interface 214 positioned at the first aperture 106, a second connection interface 210 positioned at the second aperture 102, and third connection interface 212 positioned at the third aperture 104.

The first connection interface 214 is configured to removably connect the first aperture 106 with a first respirator component. In the example configuration depicted, the first respirator component is a plug. Also shown is an annular seal 80 positioned within a groove in the surface of the face shield 100 to seal against the plug. The annular seal 80 may be a gasket, O-ring, or similar seal.

The second connection interface 210 is configured to removably connect the second aperture 102 with a second respirator component. The second connection interface 210 has a structure that is different from the first connection interface 214.

The third connection interface 212 is configured to removably connect the third aperture 104 with a third respirator component. The third connection interface has a structure that is different from the first connection interface 214 and the second connection interface 210.

The connection interfaces 210, 212, 214 having different structures allows the full-face respirator apparatus 50 to support a wide variety of respirator components and thus have a wide range of configurations. Differences in connection structures of connection interfaces may include differences in shape, size, the presence/absence of knuckles, the number of knuckles, the arrangement of knuckles, the presence/absence of notches, the number of notches, the arrangement of notches, and so on.

The full-face respirator apparatus 50 may further include a head lamp attachment structure 90 positioned at a top of the face shield 100 to receive the removable connection of a head lamp (not shown). The head lamp attachment structure 90 may be attached to the clamshell 64.

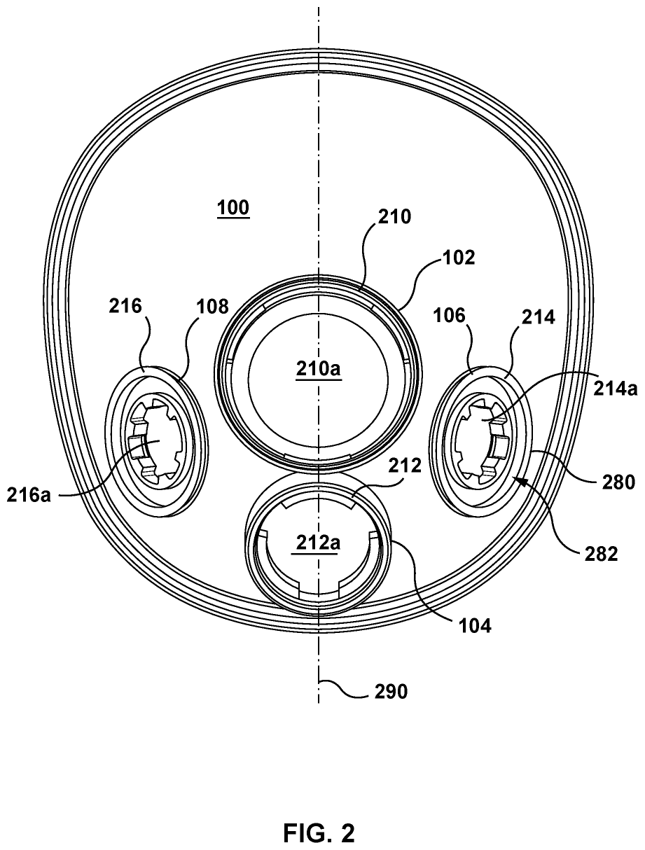

FIG. 2 is a front view of a face shield 100 according to embodiments of the present invention. Face shield 100 is a component of a full-face respirator 50 and includes a plurality of apertures 102, 104, 106, having disposed therein connection interfaces 210, 212, 214, as discussed above. In addition to the apertures 102, 104, 106, the face shield 100 may include any suitable number of one or more additional apertures. In the embodiment depicted, the face shield 100 includes an additional first aperture 108 with an additional first connection interface 216 to receive a first respirator component. The apertures 106, 108 and the connection interfaces 214, 216 are the same. Accordingly, in this embodiment, the face shield 100 includes two first apertures 106, 108 with respective first connection interfaces 214, 216 that have the same structure, one second aperture 102 with a different second connection interface 210, and one third aperture 104 with still a different third connection interface 212. In other embodiments, other combinations of three or more apertures with three or more different connection interfaces may be used.

As mentioned above, the face shield 100 may be formed of a transparent or translucent material, such as polycarbonate or silicate glass, to provide a high level of visibility. The face shield may be curved or dished for enhanced user field of view and comfort. The connection interfaces 210, 212, 214, 216 are preferably formed integrally into the apertures 102, 104, 106, 108 such as by molding of the face shield as a single piece. The connection interfaces 210, 212, 214, 216 may be formed separately and secured within each aperture in an airtight fashion. If the connection interfaces 210, 212, 214, 216 are detachable, each aperture 102, 104, 106, 108 may be adapted to detachably receive an interface 210, 212, 214, 216, respectively, in an airtight, locking fashion. Each aperture 102, 104, 106, 108 may be threaded or the like to receive the connection interfaces 210, 212, 214, 216. Alternatively, the connection interfaces 210, 212, 214, 216 may be permanently secured within the aperture, such as with an adhesive or by using thermal bonding.

Each connection interface 210, 212, 214, 216 is for detachably coupling a respirator component thereto. Respirator components may include filter assemblies, voice diaphragms, retainers, inhalation valves, exhaust valves, plugs, microphone devices, radio transmitter/receiver devices, and the like. Each connection interface 210, 212, 214, 216 includes a respective aperture 210a, 212a, 214a, 216a through which the attached component may operate. The structure of each connection interface 210, 212, 214, 216 in and/or around the respective aperture 210a, 212a, 214a, 216a may be shaped and sized to match an exterior shape and size of a coupling portion of a respective respirator component.

As shown, each aperture 210a, 212a, 214a, 216a may be provided with connecting structure, such as notches or raised knuckles for mechanically coupling a respirator component thereto in a locking and airtight fashion.

In the embodiment depicted, a ridge 280 is provided around each first connection interface 214, 216. The ridge 280 extends or protrudes from an outside surface of the face shield 100 and surrounds the first connection interface 214, 216. A recessed groove 282 is positioned at the outside surface of the face shield 100 between the ridge 280 and the outer extent of the first connection interface 214, 216. An annular seal 80 may be positioned within the groove 282 to seal between the face shield 100 and the respirator component attached to the first connection interface 214, 216.

The second and third connection interfaces 210, 212 may be positioned at a central location on the face shield 100 and the first connection interface 214, 216 may be positioned on opposite sides of the central location of the second and third connection interfaces 210, 212. In the embodiment depicted, the second and third connection interfaces 210, 212 are positioned on a central longitudinal axis 290 of the face shield 100 and each first connection interface 214, 216 is laterally offset from the central longitudinal axis 290. The first connection interfaces 214, 216 may be laterally offset on opposite sides of the central longitudinal axis 290.

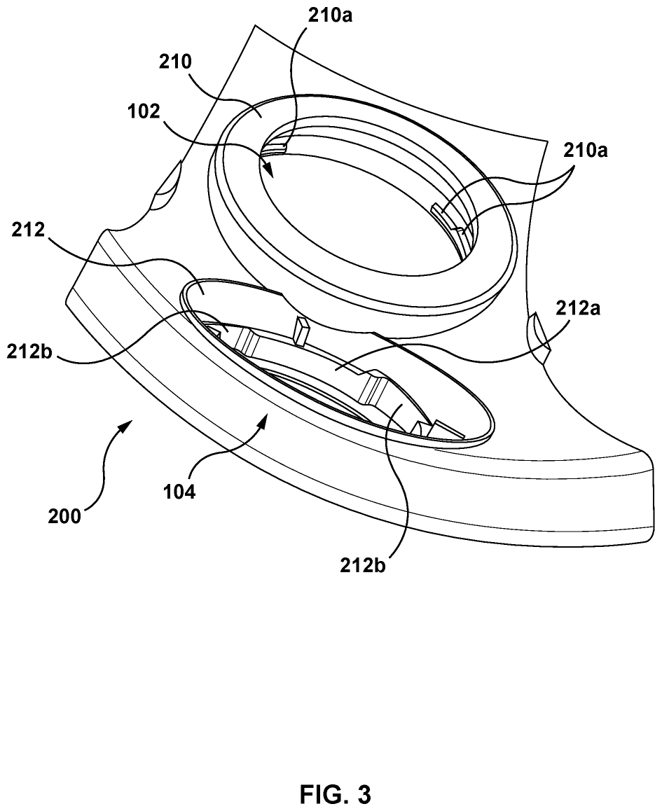

FIG. 3 illustrates a rear perspective view of a portion 200 of the face shield 100 showing connection interfaces 210, 212 installed into apertures 102, 104, according to embodiments of the present invention. Each connection interface 210, 212 includes raised knuckles 210a, 212a to rotationally engage and disengage with complementary raised knuckles of the respective respirator component. A second connection interface 210 is installed into the second aperture 102 and an third connection interface 212 installed into the third aperture 104. As shown, the interior shape of each of the interface 210, 212 may be shaped and sized to accept a complementary interface of a respirator component. For example, the second connection interface 210 includes knuckles 210a to removably couple with an exhaust valve, a voice diaphragm, or a radio transmitter/receiver device. As shown, the third connection interface 212 includes knuckles 212a for removably coupling with an inhalation valve that has a thread to connect to a complementary thread of an air supply component (e.g., a 40 mm NATO component), a plug, or an exhaust valve. The third connection interface 212 may also include notches 212b in its aperture to match a protrusion on a complementary interface of a respirator component.

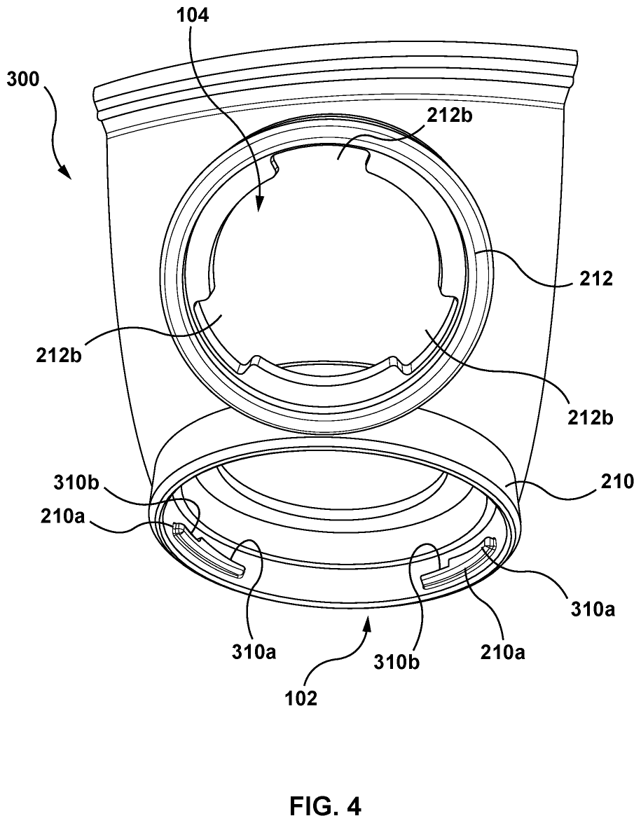

FIG. 4 illustrates a front perspective view of a portion 300 of the face shield 100 that includes second connection interface 210 integrated into the second aperture 102 and third connection interface 212 integrated into third aperture 104, according to embodiments of the present invention. From this view, one can clearly see the structure of the raised knuckles 210a formed in the surface of aperture of connection interface 210. Each knuckle 210a preferably protrudes radial towards the axis of the aperture and has a shape for removably engaging with a complementary interface of a respirator component. As shown, each knuckle 210a includes a slanted engaging surface 310a which tightens the complementary interface of a respirator component against a seal or gasket. A notch 310b is provided to the knuckle 210a for locking.

Also shown in FIG. 4 is the shape of the third connection interface 212. As shown, notches 212b are formed for accepting a complementary interface of a respirator component having matching protrusions. Such notches may be necessary to conform with certain industry standard interfaces. In some embodiments, the connection interface 212 may comply with a 40 mm NATO standard.

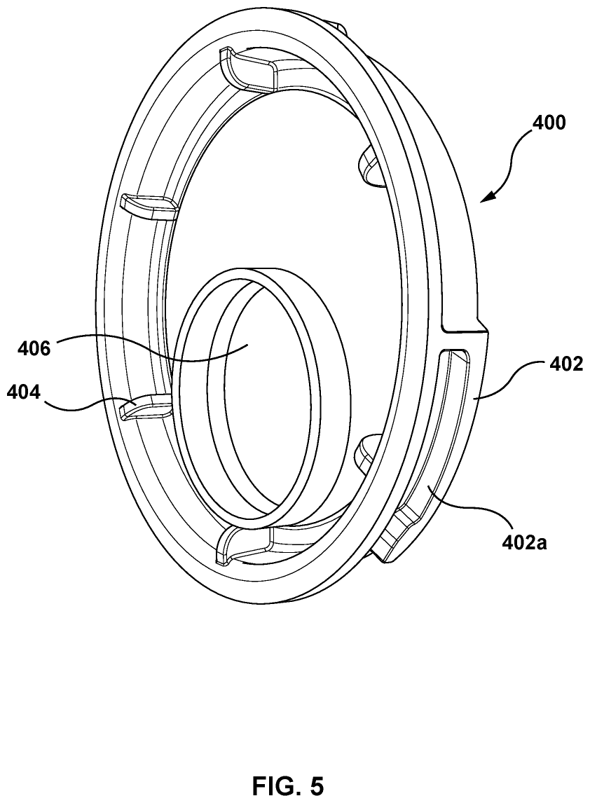

FIG. 5 is a perspective view of an exhaust valve insert 400, which is an example of a respirator component that may be detachably coupled with connection interface 210 according to embodiments of the present invention. As shown, the exterior shape of exhaust valve insert 400 matches the shape of the connection interface 210 in such a way to allow for exhaust valve insert 400 to be detachably coupled with the connection interface 210. Exhaust valve insert 400 includes raised knuckles 402 to interface with and lock onto knuckles 210a and has an engaging surface 402a shaped so as to engage surface 310a via rotation into a mechanical lock that provides a secure, air-tight connection, that will not easily unlock on its own, but can be unlocked by turning. Teeth 404 may be provided to assist gripping of the exhaust valve insert 400 for rotating into place or unlocking and removing. Exhaust valve insert 400 also includes an aperture 406 for receiving a valve assembly (not shown).

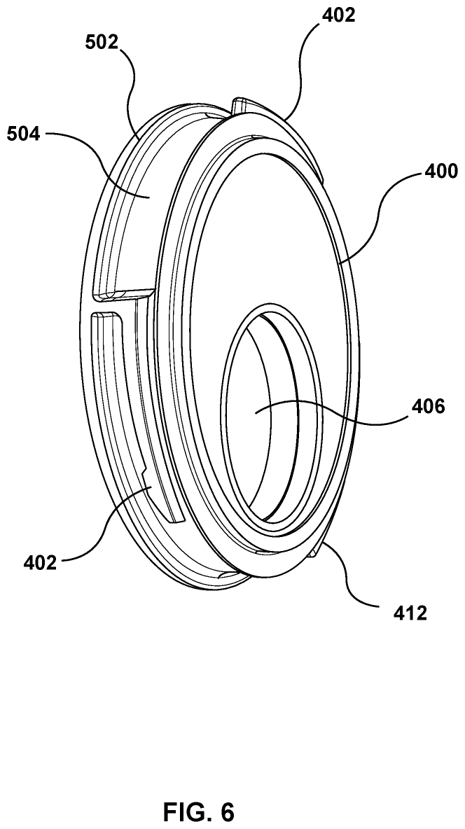

FIG. 6 is a side view of exhaust valve insert 400 which shows the circumferential shape thereof, according to embodiments of the present invention. A ridge 502 is formed in the circumference and rises above a land (surface) 504 that runs circumferentially around exhaust valve insert 400. Knuckle 402 is formed in the circumferential surface within the groove 504 and extends radially the same distance as ridge 502b. Three knuckles 402 may be formed equidistant in the circumferential direction according to a preferred embodiment of the present invention. This shape allows for an airtight coupling to be formed with the connection interface 210.

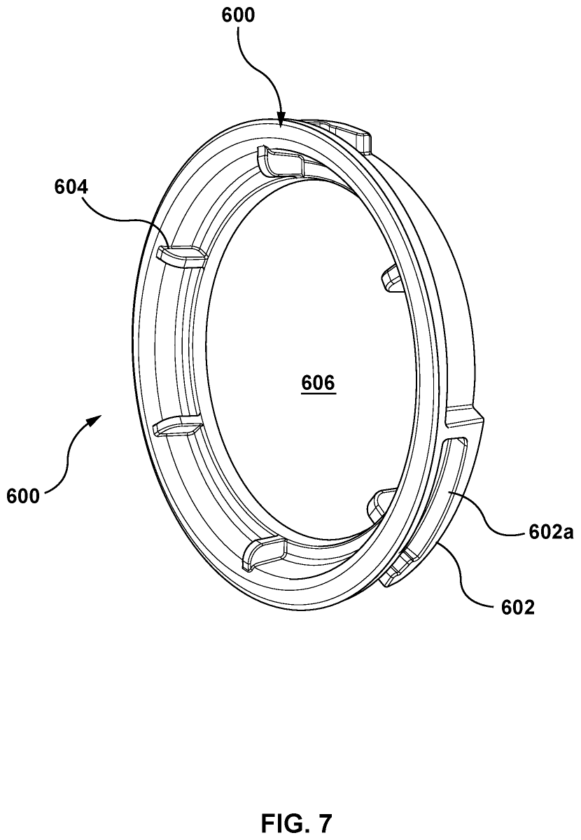

FIG. 7 is a perspective front view of a voice diaphragm retainer 600 which may be inserted into a connection interface installed in face shield component 100 according to embodiments of the present invention. As shown, the exterior shape of voice diaphragm retainer 600 complements the shape of the connection interface 210 in such a way to allow for voice diaphragm retainer 600 to be detachably coupled to the connection interface 210. The voice diaphragm retainer 600 includes raised knuckles 602 to interface with and lock onto knuckles 210a of the connection interface 210. The voice diaphragm retainer 600 includes an engaging surface 602a shaped so as to engage surface 310a of the connection interface 210 via rotation into a mechanical lock that provides a secure, airtight connection, that will not easily unlock on its own, but can be unlocked by turning. Teeth 604 may be provided to assist gripping of the voice diaphragm retainer 600 for rotating into place or unlocking and removing. The voice diaphragm retainer 600 also includes an aperture 606 for receiving a voice diaphragm (not shown).

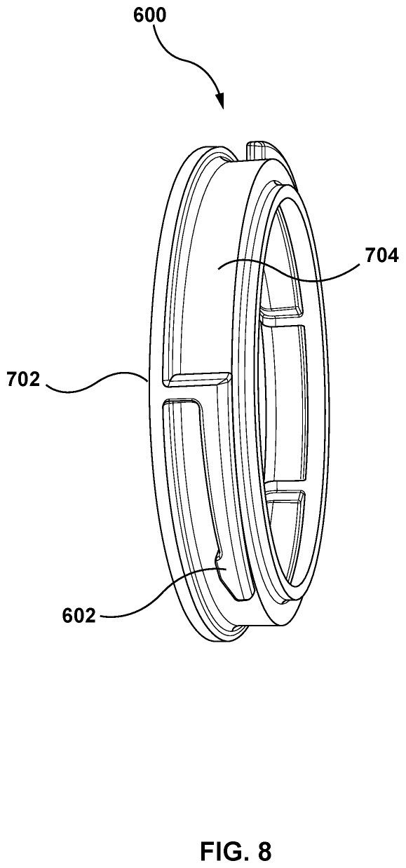

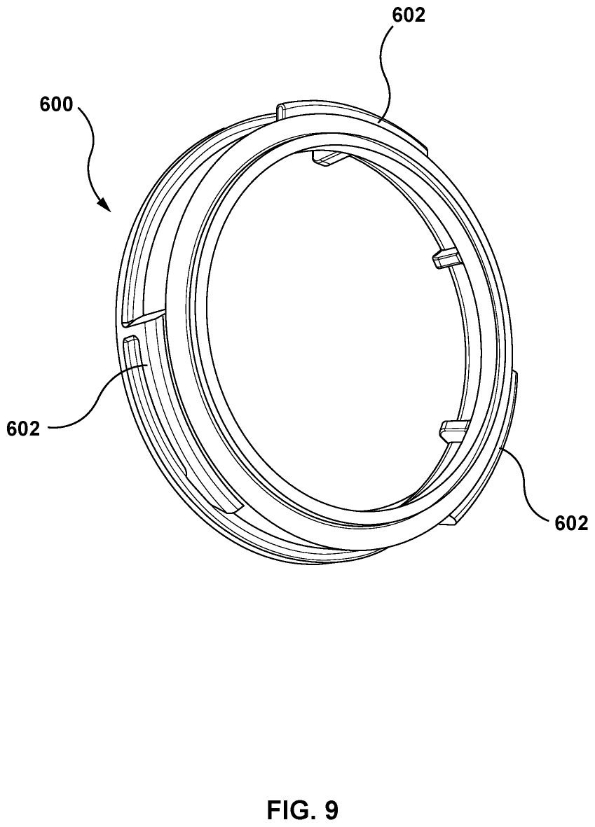

FIG. 8 is a side view of the voice diaphragm retainer 600. As shown, a ridge 702 is formed in the circumference to create a recessed face 704 circumferentially around exhaust valve insert 400. Knuckle 602 is formed in the circumferential surface on the recessed face 704 and extends radially the same distance as ridge 702. Three knuckles 602 may be formed equidistant in the circumferential direction according to a preferred embodiment of the present invention. This shape allows for an airtight coupling to be formed with the connection interface 210. FIG. 9 is a rear perspective view of a voice diaphragm retainer 600 showing knuckles 602 equally spaced about the circumferences of retainer 600.

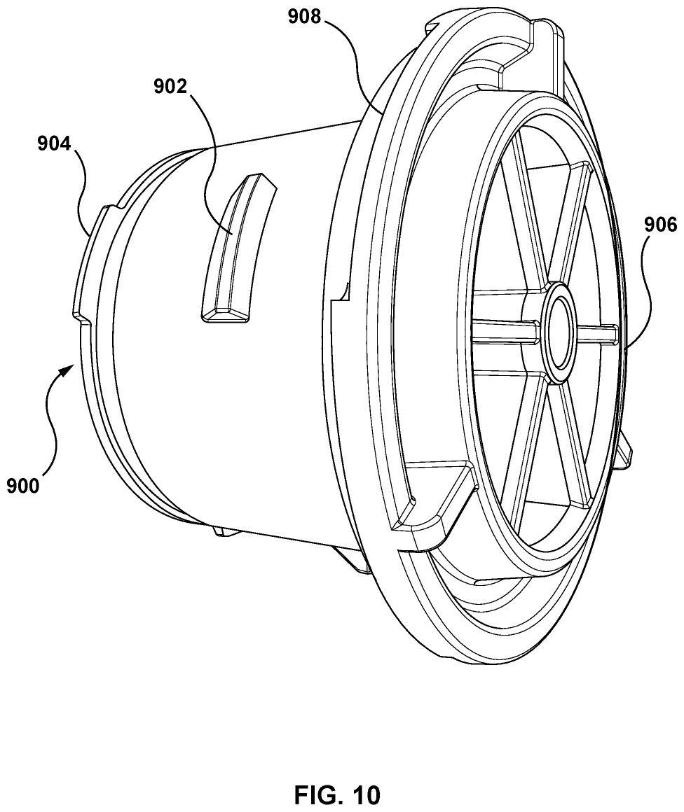

FIG. 10 is a side view of an exhaust valve 900 which may be inserted into a connection interface installed in face shield component 100 according to embodiments of the present invention. Exhaust valve 900 is preferably formed to have a shape that matches the shape of the third connection interface 212. Exhaust valve 900 includes knuckles 902 and protrusions 904 to match knuckles 212a and notches 212b of the connection interface 212. That is, both the protrusions 904 and knuckles 902 may be lined up with notches 212b for insertion into interface 212, and then when exhaust valve 900 is rotated, knuckles 902 engage with knuckles 212a to effect a mechanical lock that provides a secure, airtight connection, that will not easily unlock on its own, but can be unlocked by turning. The valve assembly (not shown) may be installed within the body of the valve 900 behind grate 906. In some embodiments, the connection interface 212 and exhaust valve 900 comply with a 40 mm NATO standard.

FIG. 11 is a rear view of exhaust valve 900 showing knuckles 902 formed equidistant radially about the outer circumference of the body of exhaust valve 900. In this example, there are three knuckles 902.

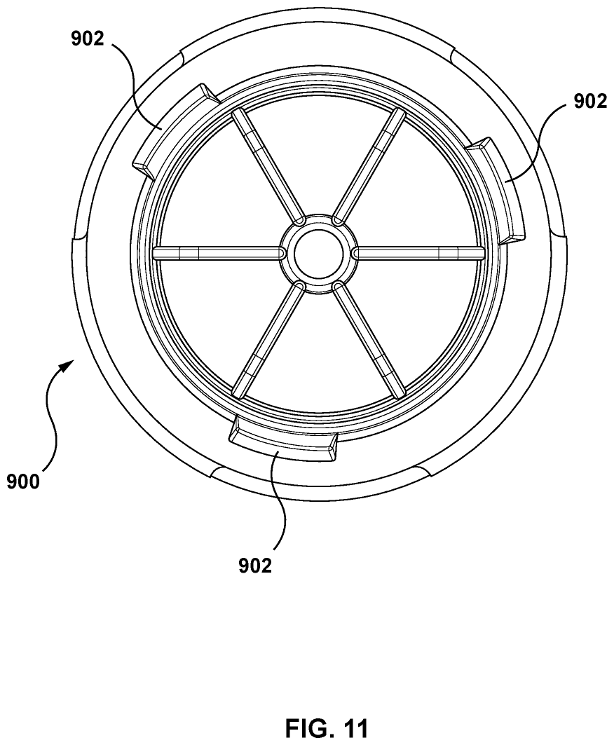

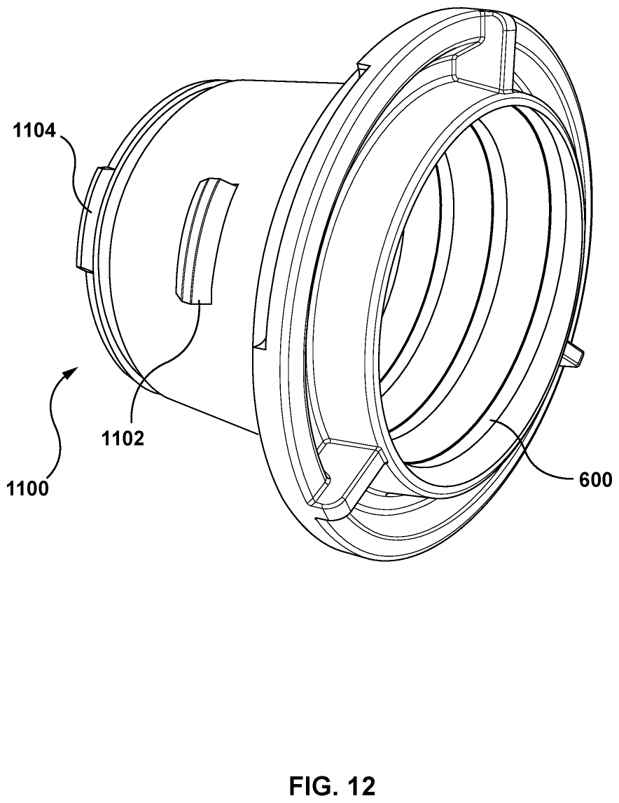

FIG. 12 is a side view of an inhalation valve (with filter attachment part) 1100 which may be inserted into a connection interface installed in face shield component 100 according to embodiments of the present invention. Inhalation valve 1100 is preferably formed to have a shape that matches the shape of the third connection interface 212. Inhalation valve 1100 includes knuckles 1102 and protrusions 1104 to match knuckles 212a and notches 212b of the third connection interface 212. That is, both the protrusions 1104 and knuckles 1102 may be lined up with notches 212b for insertion into the connection interface 212, and then when inhalation valve 1100 is rotated, knuckles 1102 engage with knuckles 212a to effect a mechanical lock that provides a secure, airtight connection, that will not easily unlock on its own, but can be unlocked by turning. The valve assembly (not shown) may be installed within the body of the valve 1100. The inhalation valve 1100 may include an internal thread 600 to accept a thread connection of a standard 40 mm NATO filter. In other embodiments, the internal thread 600 may be configured to mate with an air supply inlet component, such as a tube or hose. In some embodiments, the connection interface 212 and the inhalation valve 1100 comply with a 40 mm NATO standard.

FIG. 13 is a rear view of inhalation valve 1100 showing knuckles 1102 formed equidistant radially about the outer circumference of the body of exhaust valve 1100. In this example, there are three knuckles 1102.

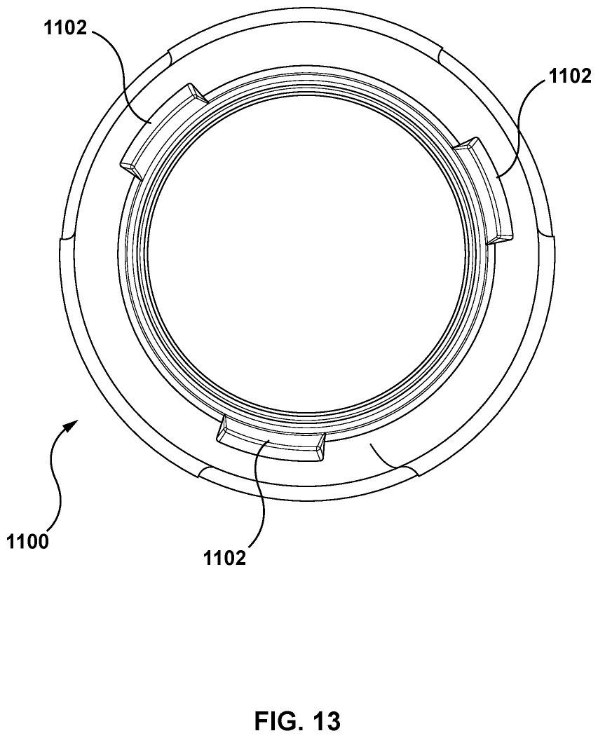

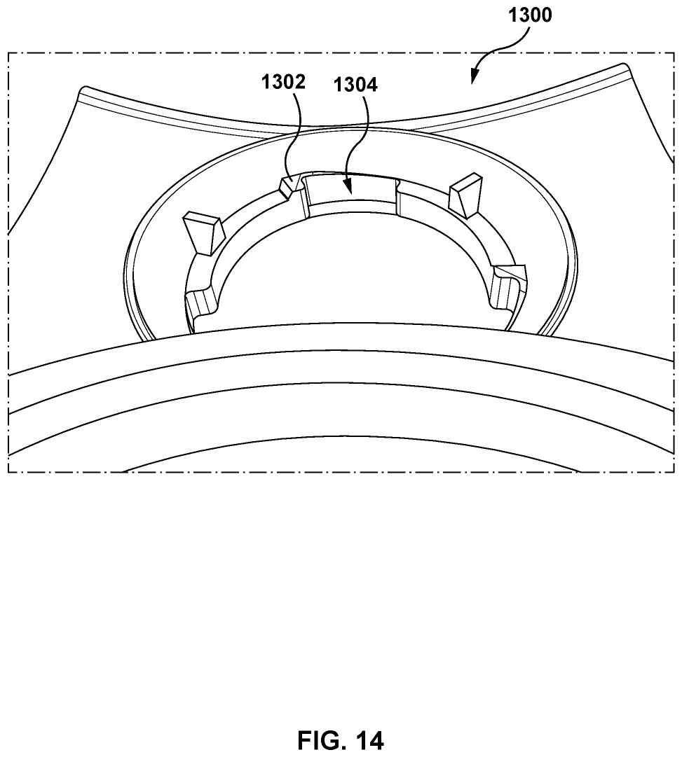

FIG. 14 is a rear perspective view of the connection interface 214, 216 according to an embodiment of the present invention. As shown, the connection interface 214, 216 may include raised knuckles 1302 for engaging with knuckles formed on a respirator component to be inserted therein. In this embodiment, the connection interface 214, 216 also includes notches 1304 for accepting a matching protrusion on a respirator component. Each knuckle 1302 may be formed adjacent a notch 1304 so that little rotation is required to lock a component into place.

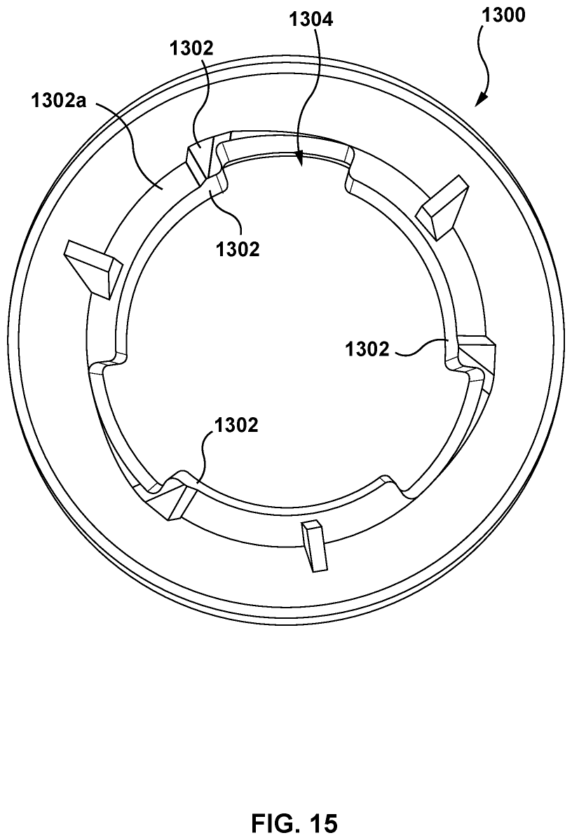

FIG. 15 is a rear view of the connection interface 214, 216. As shown, the connection interface 214, 216 includes three notches 1304 and three knuckles 1302 formed equidistant radially about the outer circumference of the interface. Referring to FIGS. 14 and 15 together one can see the shape of the engaging surface 1302a of knuckles 1302 is configured to create a mechanical lock with a component having matching knuckles, when inserted into notches 1304 and rotated. A preloading mechanism such as a gasket or the like can be placed between the component and the outer surface of the connection interface 214, 216 to assist with the locking. By pressing and turning the component in the opposite direction, the component can be easily unlocked and removed.

Preferably, the face shield 100 includes three, four, or more different connection interfaces is a single, molded component. Each removable respirator component preferably has a body that matches the shape of one or more of the connection interfaces. This modularity allows the same full-face respirator may be configured with different combinations of respirator components by installing different connection interfaces. Moreover, connection interfaces, when made removeable, and/or respirator components may be readily attached and detached to facilitate repair and maintenance.

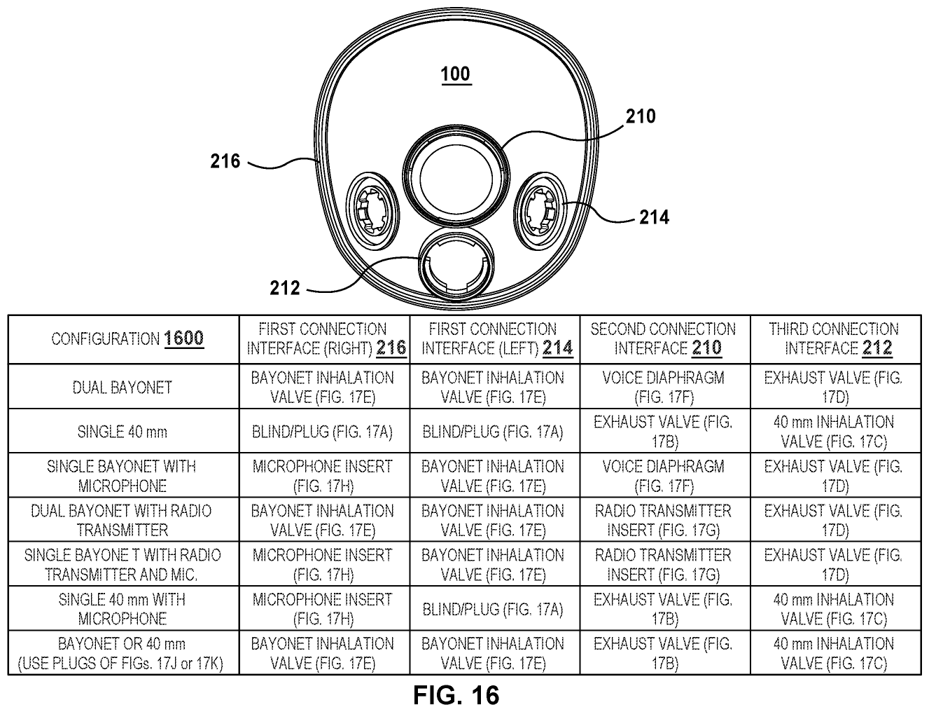

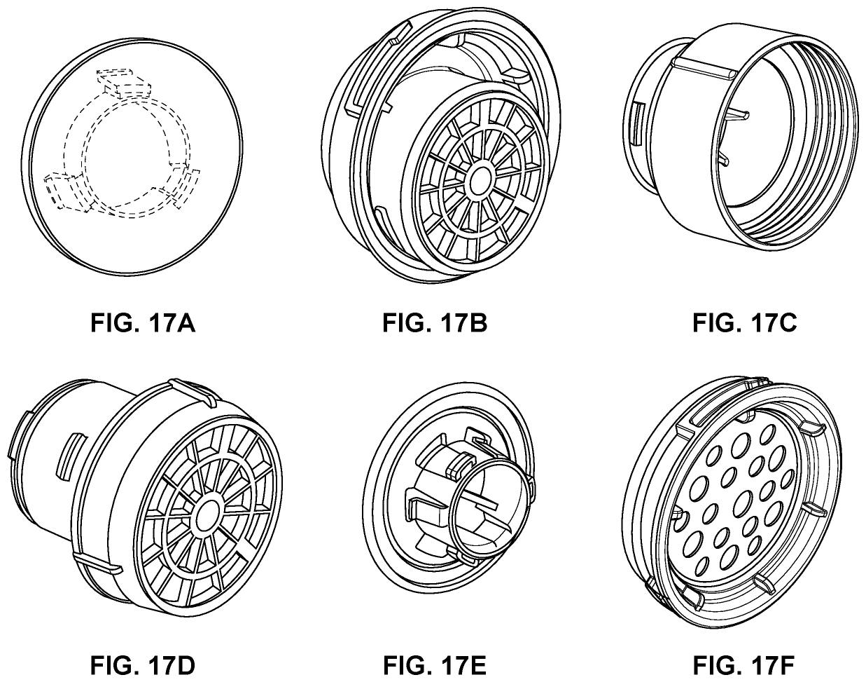

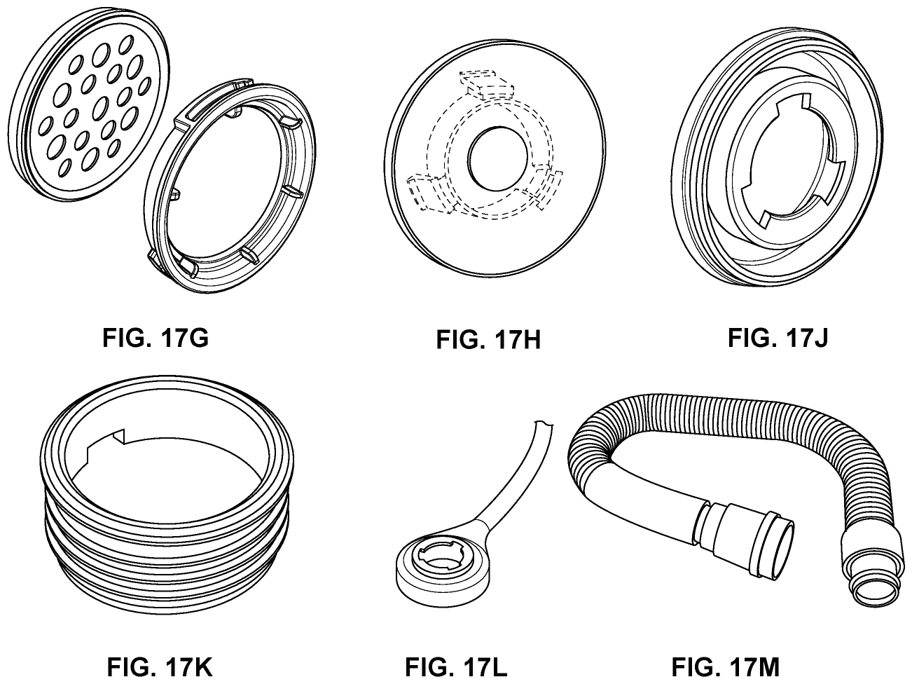

FIGS. 16 and 17A-17M show various example configurations 1600 possible with the apparatus 100 using the same face shield 100.

FIG. 17A shows a plug (blind) configured to connect to the first connection interface 214, 216.

FIG. 17B shows an exhaust valve configured to connect to the second connection interface 210.

FIG. 17C shows a 40 mm filter attachment point and inhalation valve configured to connect to the third connection interface 212.

FIG. 17D shows a 40 mm exhaust valve configured to connect to the third connection interface 212.

FIG. 17E shows a bayonet filter attachment point and inhalation valve configured to connect to the first connection interface 214, 216.

FIG. 17F shows a voice diaphragm configured to connect to the second connection interface 210.

FIG. 17G shows a radio transmitter/receiver device configured to connect to the second connection interface 210.

FIG. 17H shows a microphone insert configured to connect to the first connection interface 214, 216.

FIG. 17J shows a bayonet plug (blind) that may be used to close the bayonet inhalation valve of FIG. 17E.

FIG. 17K shows a 40 mm threaded plug (blind) that may be used to close the 40 mm inhalation valve of FIG. 17C.

FIG. 17L shows a bayonet style air hose that may be used to supply clean air to the bayonet inhalation valve of FIG. 17E.

FIG. 17M shows a 40 mm air hose that may be used to supply clear air to the 40 mm inhalation valve of FIG. 17C.

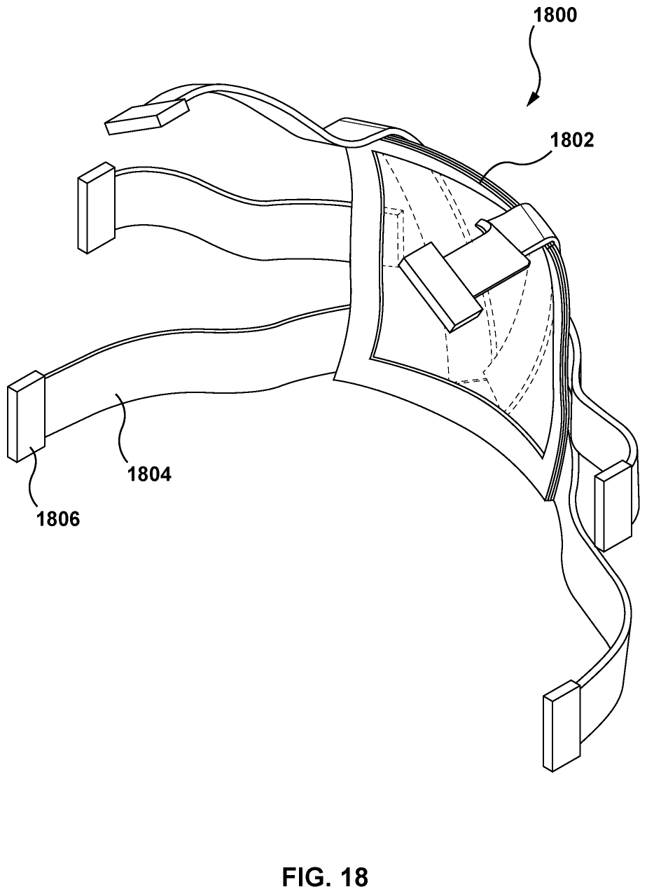

FIG. 18 shows an example harness 1800 for securing the full-face respirator 50 to a wearer's head. The harness 1800 includes a rear panel 1802 of flexible material to conform to the wearer's head. Straps 1804 extend from the rear panel 1802 around the perimeter of the rear panel 1802. Each strap 1804 has an attached fastener 1806, such as a clip or buckle component, to releasably engage with a complementary fastener 72 of the face seal 60. The fastener 1806 may be a quick-connect/quick release fastener to allow quick donning/removal of the full-face respirator apparatus 50.

The present invention has been described in the context of a number of embodiments, and multiple variations and examples thereof. It is to be understood, however, that other expedients known to those skilled in the art or disclosed herein may be employed without departing from the spirit of the invention.

Any references to the “invention” herein do not and are not intended to identify or describe aspects or embodiments that are required or otherwise essential to the present invention unless expressly stated as such.

What is claimed is:

1. A full-face respirator apparatus comprising:
a face shield including a first aperture, a second aperture, and a third aperture;
a first connection interface positioned at the first aperture, the first connection interface to removably connect the first aperture with a first respirator component;
a second connection interface positioned at the second aperture, the second connection interface to removably connect the second aperture with a second respirator component, wherein the second connection interface has a structure different from the first connection interface; and
a third connection interface positioned at the third aperture, the third connection interface to removably connect the third aperture with a third respirator component, wherein the third connection interface has a structure different from the first connection interface and the second connection interface.

2. The full-face respirator apparatus of claim 1, wherein the first connection interface includes notches to slidably engage and disengage with complementary flexible tabs of the first respirator component.

3. The full-face respirator apparatus of claim 2, wherein the second connection interface includes raised knuckles to rotationally engage and disengage with complementary raised knuckles of the second respirator component.

4. The full-face respirator apparatus of claim 3, wherein the third connection interface includes raised knuckles to rotationally engage and disengage with complementary raised knuckles of the third respirator component.

5. The full-face respirator apparatus of claim 1, wherein the first connection interface is shaped and sized to receive the first respirator component that is:
a plug;
an inhalation valve with a bayonet connector to connect to a complementary bayonet connector of an air supply component or a plug; or
a microphone device.

6. The full-face respirator apparatus of claim 1, wherein the second connection interface is shaped and sized to receive the second respirator component that is:
an exhaust valve;
a voice diaphragm; or
a radio transmitter or receiver device.

7. The full-face respirator apparatus of claim 1, wherein the third connection interface is shaped and sized to receive the third respirator component that is:
an inhalation valve with a thread to connect to a complementary thread of an air supply component or a plug; or
an exhaust valve.

8. The full-face respirator apparatus of claim 1, further comprising a ridge extending from an outside surface of the face shield and surrounding the first connection interface.

9. The full-face respirator apparatus of claim 8, further comprising a groove positioned between the ridge and the first connection interface

10. The full-face respirator apparatus of claim 9, further comprising an annular seal positioned within the groove.

11. The full-face respirator apparatus of claim 1, further comprising an additional first connection interface positioned at an additional first aperture in the face shield, the additional first connection interface to removably connect the additional first aperture with the first respirator component.

12. The full-face respirator apparatus of claim 1, wherein:
the second and third connection interfaces are positioned on a central longitudinal axis of the face shield; and
the first connection interface is laterally offset from the central longitudinal axis.

13. The full-face respirator apparatus of claim 12, further comprising:
an additional first connection interface positioned at an additional first aperture in the face shield, the additional first connection interface to removably connect the additional first aperture with the first respirator component;
wherein the additional first connection interface is laterally offset from the longitudinal axis at a side opposite the first connection interface.

14. The full-face respirator apparatus of claim 1, further comprising a head lamp attachment structure at a top of the face shield to receive removable connection of a head lamp.

15. A full-face respirator apparatus comprising:
a face shield including a first aperture, a second aperture, and a third aperture;
a first connection interface positioned at the first aperture;
a first respirator component including a plug, an inhalation valve with a bayonet connector to connect to a complementary bayonet connector of an air supply component or a plug, or a microphone device;
wherein the first connection interface is configured to removably connect the first aperture with the first respirator component;
a second connection interface positioned at the second aperture;
a second respirator component including an exhaust valve, a voice diaphragm, or a radio transmitter or receiver device;
wherein the second connection interface is configured to removably connect the second aperture with the second respirator component, wherein the second connection interface has a structure different from the first connection interface;
a third connection interface positioned at the third aperture; and
a third respirator component including an inhalation valve with a thread to connect to a complementary thread of an air supply component or a plug, or an exhaust valve;
wherein the third connection interface is configured to removably connect the third aperture with the third respirator component, wherein the third connection interface has a structure different from the first connection interface and the second connection interface.

16. The full-face respirator apparatus of claim 15, further comprising:
an additional first connection interface positioned at an additional first aperture in the face shield;
wherein the additional first connection interface is configured to removably connect the additional first aperture with the first respirator component including a plug, an inhalation valve with a bayonet connector to connect to a complementary bayonet connector of an air supply component or a plug, or a microphone device.

17. The full-face respirator apparatus of claim 16, wherein:
the second connection interface and the third connection interface are positioned at a central location on the face shield; and
the first connection interface and the additional first connection interface are positioned on opposite sides of the central location on the face shield.
